(19) United States
(12) Patent Application Publication
(10) Pub. No.: US 2003/0041305 A1
(43) Pub. Date: Feb. 27, 2003

(54) Resilient data links

(76) Inventors: Christoph Schnelle, New South Wales (AU); Geoffrey John Nolan, New South Wales (AU)

Correspondence Address: Clifford W. Browning, Woodard, Emhardt, Naughton, Moriarty & McNett, Bank One Center/Tower, 111 Monument Circle, Suite 37, Indianapolis, IN, 46204-5137, US

(21) Appl. No.: 10/196,802

(22) Filed: Jul. 17, 2002

Related U.S. Application Data
(60) Provisional application No. 60/306,177, filed on Jul. 18, 2001.

(51) Int. Cl. G06F 15/00

(52) U.S. Cl. 715/513

(57) ABSTRACT

A method is disclosed for providing one or more resilient links in an electronic document using text-based data. In the method, an XML dataset is provided including a plurality of predefined portions of text-based data, each predefined portion of the text-based data being encoded using XML, and a plurality of attributes for organising the predefined portions of the text-based data. An XML link is embedded in the electronic document for at least partially identifying one or more predefined portions in the XML dataset. A request is generated for at least one of the partially identified predefined portions based upon activation of the embedded XML link. The request using at least one current context variable is resolved to determine a specific one of the partially identified predefined portions.

### TECHNICAL FIELD OF THE INVENTION

The present invention relates generally to electronic documents and, in particular, to maintaining links among evolving electronic documents.

### BACKGROUND

International Publication No. WO 98/34179 (PCT/AU98/00050) in the name of Time Base Pty Ltd and published on Aug. 6, 1998 and counterpart U.S. Pat. No. 6,233,592 issued on May 15, 2001 to Schnelle et al. are incorporated herein by cross reference. In these documents, an electronic publishing system is disclosed that provides a sparse multidimensional matrix of data using a set of flat file records. In particular, the computer-implemented system publishes an electronic publication using text-based data. Predefined portions of the text-based data are stored and used for the publication. At least one of the predefined portions is modified, and the modified version is stored as well. The predefined portion is typically a block of text, greater in size than a single word, but less than an entire document. Thus, for example, in the case of legislation, the predefined portion may be a section of the Act. Each predefined portion and the modified portion(s) arc marked up with one or more links using a markup language, preferably SGML or XML. The system also has attributes, each being a point on an axis of a multidimensional space for organising the predefined portions and the modified portion(s) of the text-based data. This system is simply referred to as the Multi Access Layer Technology or “MALT” system hereinafter.

Australian Patent Application No. 65470/00 filed on Oct. 12, 2000 in the name of TimeBase Pty Ltd, Canadian Patent Application No. 2323245 filed on Oct. 12, 2000 in the name of TimeBase Pty Ltd, New Zealand Patent Application No. 507510 filed on Oct. 12, 2000 in the name of TimeBase Pty Ltd and U.S. Pat. Application Ser. No. 09/689927 filed on Oct. 12, 2000 in the names of Lessing et al. are incorporated herein by cross reference.

Electronic publications often utilise links to provide cross references from a source publication to one or more relevant target publications. Links may also be used to connect related sections within a single electronic document. An artefact is an area of a visibly rendered Web page that invokes some function when activated by a user. Activation may result from a user clicking the artefact or moving a cursor over the artefact. A typical page on the World Wide Web has one or more artefacts, which may typically take the form of a button, an icon or text. A destination is a distinguished location in a dataset, which can be identified by a single, unique identifier. A dataset is a set of data possessing complex structure that may be rendered in a number of various formats. Such formats may include an XML document, SQL tables, or a World Wide Web page. A link on a World Wide Web page typically comprises a screen artefact that initiates a transfer to a specified, related destination. Similarly, a link in a document marked up using the XML mark-up language provides a reference identifier, which uniquely identifies a specific element in a related dataset.

HTML hyperlinks and the like provide a useful tool for readily cross referencing electronic publications. Difficulties arise, however, when such cross referenced documents are changed, moved or deleted. Such actions may render the links between the cross-referenced documents obsolete or irrelevant. Consequently, a major and continuing problem with web-based architectures and other collections of documents and publications like manuals, software help systems and compound documents, in general, is the problem of “broken” links, which occur when the target of a link is either moved, removed or updated such that the target's content is no longer relevant to the source document.

Thus, a need exists for providing resilient data links that allow a dataset to evolve, whilst guaranteeing the integrity of internal cross references. The resilient data links should preferably allow complex cross-references to be coded without increasing the complexity of data markup.

### SUMMARY

According to a first aspect of the invention there is provided a method for providing one or more resilient links in an electronic document using text-based data, the method including the steps of:

providing an XML dataset including a plurality of predefined portions of textbased data, each predefined portion of the text-based data being encoded using XML, and a plurality of attributes for organising the predefined portions of the text-based data;

embedding an XML link in the electronic document for at least partially identifying one or more predefined portions in the XML dataset;

generating a request for at least one of the partially identified predefined portions based upon activation of the embedded XML link; and

resolving the request using at least one current context variable to determine a specific one of the partially identified predefined portions.

According to a second aspect of the invention there is provided an apparatus for providing one or more resilient links in an electronic document using text-based data, the apparatus including:

a device for providing an XML dataset including a plurality of predefined portions of text-based data, each predefined portion of the text-based data being encoded using XML, and a plurality of attributes for organising the predefined portions of the text-based data;

a device for embedding an XML link in the electronic document for at least partially identifying one or more predefined portions in the XML dataset;

a device for generating a request for at least one of the partially identified predefined portions based upon activation of the embedded XML link; and

a device for resolving the request using at least one current context variable to determine a specific one of the partially identified predefined portions,

According to another aspect of the invention there is provided a computer program product including a computer readable medium having recorded thereon a computer program for implementing the method described above.

### BRIEF DESCRIPTION OF THE DRAWINGS

One or more embodiments of the present invention are described hereinafter with reference to the drawings, in which:

FIG. 1 is a schematic block diagram representation of a pointer associated with a dataset of links;

FIG. 2 is a schematic block diagram representation of cross-referenced electronic publications utilising a pointer in accordance with an embodiment of the present invention;

FIG. 3 is a flow diagram for providing one or more resilient links in an electronic publication; and

FIG. 4 is a schematic block diagram representation of a general-purpose computer system on which a method for providing resilient links in an electronic publication may be practised.

### DETAILED DESCRIPTION

A method, apparatus and computer program product for providing one or more resilient links in an electronic document are described. In the following description, numerous details are set forth. It will be apparent to one skilled in the art, however, that the present invention may be practised without these specific details. In other instances, well-known features are not described in detail so as not to obscure the present invention.

A pointer is a data entity or element that points to the location of another data entity or element, preferably to a set of destinations, rather than a single unique destination. A specific destination may only be selected from the set by providing the pointer in conjunction with one or more context variables. A monotonic dataset is one in which a destination, once created, may not be removed. In such a monotonic dataset, a data pointer is always valid. Any dataset that allows point-in-time or similar query capability, is monotonic. Thus, a data pointer assumes the function of an arbitrarily large set of unbreakable links. In XML, a pointer identifies a set of elements in a dataset In the World Wide Web (WWW), a pointer is a screen artifact that initiates a transfer to one of a set of specified destinations, as determined by a current context.

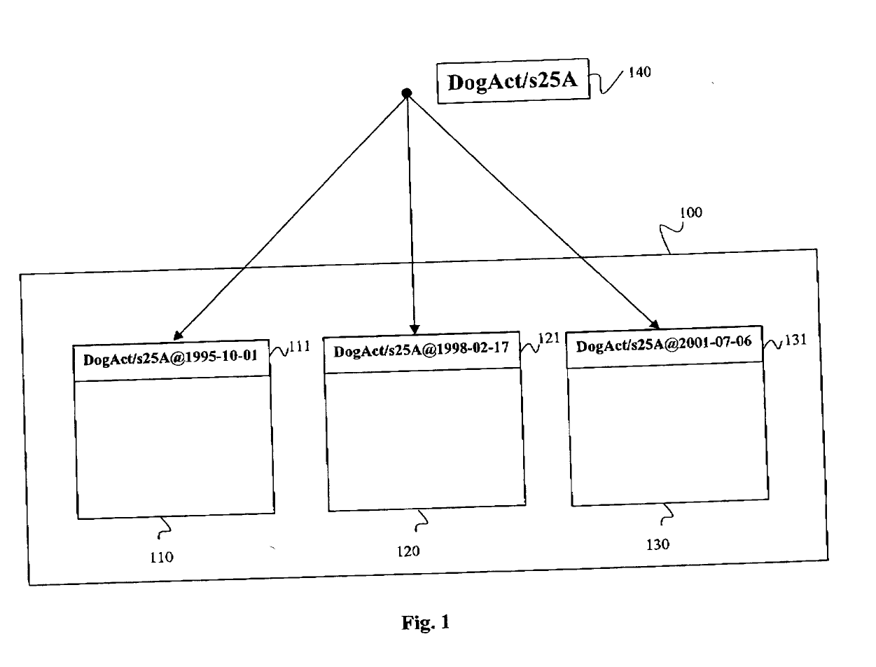

In XML, a data pointer is typically represented as an attribute whose value can, in some manner, impute all of the destinations to which the pointer may refer. Consider a piece of legislation (e.g. Section 25A of the Dog Act) that was created in 1995 and subsequently amended twice, once in 1998 and again in 2001. FIG. 1 shows three versions 110, 120 and 130 of s25A, corresponding respectively to the original legislation and two subsequently amended versions. The three versions 110, 120 and 130 constitute the elements of a dataset 100.

A first identifier 111 provides a reference to an explicit destination of that version of section 25A of the Dog Act that came into force on Oct. 1, 1995. Similarly, a second identifier 121 provides a reference to an explicit destination of the version of section 25A of the Dog Act which came into force on Feb. 17, 1998. A third identifier 131 provides a reference to an explicit destination of the version of section 25A of the Dog Act that cane into force on Jul. 6, 2001. The first, second and third identifiers 111, 121 and 131 may be represented as:

DogAct/s25A@1995-10-01;

DogAct/s25A@1998-02-17; and

DogAct/s25A@2001-07-06, respectively.

A pointer 140 to the dataset 100 that encompasses all of the identifiers 111, 121 and 131 may simply be “DogAct/s25A”, which provides a reference to that version of s25A of the Dog Act which is appropriate to a current context. The current context relates to a condition whose value influences which element of the pointer's dataset is accessed. For example, the current context may relate to a current date or a version number. The nature of that context is not defined within the XML dataset, but is a function of an end web-delivery application. Thus, the pointer “DogAct/s25A” 140 identifies the three possible versions 111, 121 and 131 of the Dog Act and one or more context variables, perhaps in the form of a date, enable the correct version to be chosen for the context.

In the above example, the pointer markup “DogAct/s25A” is actually simpler than the specific destination identifiers 111, 121 and 131, but the opposite can also be the case Consider specific destinations:

Chap03.versionA; and

Chap03.versionB. These destinations may constitute a dataset associated with a pointer

Chap03.version[A-J].

In this instance, the pointer markup is more complex than the individual destination identifiers. The exact form of the reference is not significant, provided that the reference can reliably impute exactly that set of destinations to which the pointer may refer.

The use of pointers in no way prevents specific links from being employed where necessary. However, certain classes of datasets frequently use pointers where possible. Returning to the Dog Act example, consider a section such as:

73. Penalties

The penalties for breaching the provisions of Part 2 of this act are set out in section 25A.

The links, denoted by underlining, refer to Part 2 and section 25A, respectively, as at a particular target date. For example, if a dog attacked a child on May 11, 2000, then the penalties are those prescribed by s25A on that date. As seen above, s25A came into existence in 1995 and was amended in 1998 and again in 2001. Thus, the relevant legislation for this incident is the legislation amended in 1998. The following markup can be used to access the correct version of s25A:

<section id=“DogAct/s73” sdate=“1996-12-01”>

<label>73</label><desc>penalties</desc>

<p>The penalties for breaching the provisions of

<link ref=“DogAct/pt2@1994-07-31”>Part 2</link>of this act are set out in <link ref=“DogActs25A@1998-02-17”>section 25A</link>.</p>

</section>Now consider the situation in which the incident occurred in 1997. In this case, the link leads to an earlier version of s25A. Two versions ofs73, each linked appropriately to the different versions of s25A, provide a solution. However, consider the case in which there are many links to various sections, all having multiple associated versions. A single version of s73 may be created with multiple links, each link being associated with a date range to provide cross-references to the relevant versions for given date contexts. Such an approach works, but is extremely complex to implement. The complexity notwithstanding, whenever a new version of any section is created, every other section linked to that section has to be modified accordingly, This results in severe maintenance difficulties.

Using pointers, however, the markup can be simplified significantly. The markup of the pointer for the above situation may be:

<p>The penalties for breaching the provisions of

<pointer ref“DogAct/pt2”>Part 2</pointer>of this act are set

out in <pointer ref=“DogActs25A”>section 25A</pointer>.</p>

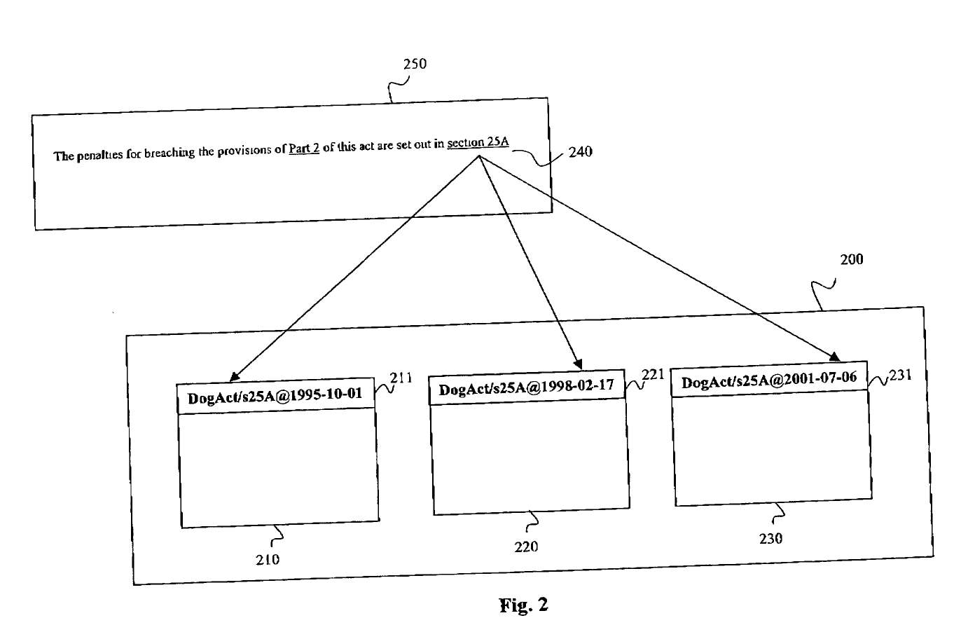

FIG. 2 shows a piece of legislation 250 that defines the penalties for breaching provisions of the Dog Act. The penalties are set out in section 25A and a pointer 240 links the piece of legislation 250 to the various versions of section 25A of the Dog Act, shown as 210, 220 and 230. The manner in which the pointer 240 is marked up instructs an end web-delivery application to provide a version of section 25A appropriate to a current context. A web application must support a context variable. In the current example, the context is the current date and the context variable may typically be implemented as a browser site JavaScript variable.

Unlike links, which link to a specific location, pointers point towards a set of locations. A version of s25A is required, but the particular version is not known at this point The markup of the pointer, in association with a context variable, is able to designate the correct version.

The above markup can be utilized directly in a (XML enabled) web browser. However, since the pointers typically need to be resolved in real time, it is usually more expedient to convert the dataset to a form that allows rapid retrieval and processing, such as an SQL table set.

The means of resolving a pointer into a unique set of destinations must be preserved. From a performance viewpoint, a table structure should itself desirably support this resolution (for example, by placing the destination information in one or more fields which can be indexed to advantage). The precise methods used necessarily depend on the nature of the pointers and links themselves.

The XML markup of a pointer is crucial, but relatively straightforward. The implementation of a pointer on a web page is considerably more complex. An essential precondition is that the Web application must support a context variable (multiple variables are possible, but logically equivalent to a single value) The context variable must be correct at all times, and therefore is typically implemented as a browser side JavaScript variable. In the Dog Act example above, the context may be the current date.

Now consider the screen view of the pointer. Since hyperlinks are the normal means of Web navigation, a pointer is usually represented on screen just as If the pointer was a standard link. Whilst a user may, therefore, perceive a pointer as being a standard link, clicking on the “link” actually triggers a JavaScript function that packages and sends a suitable request to a web server. The processing of the pointer and the context variable to provide a resolved destination may be performed on either the browser side or on the server side.

In the Dog Act example, consider the situation in which the current context date is May 11, 2000. Clicking on the s25A “link” sends the server a URL such as:

http://www.mycompany.com/legislation?pointer=DogAct/s25A&context=2000-05-11

The server then determines which stored version of the Dog Act s25A is appropriate to the context, For example, the server may emit an SQL query such as:

SELECT TOP 1 dest

FROM nodes

WHERE location =‘DogAct/s25A’

AND start_date<=‘2000-05-1’

ORDER BY start_date DESC

in which nodes are defined to be discrete structural data units of the dataset under consideration. In other words, the latest version of s25 is selected that commenced on or before the current context date. A similar search strategy may be adopted for other storage modes. In the example, the selected destination is “DogAct/s25A@1998-02-17”. The server has thus converted a general pointer into a specific link appropriate to the current context and can return the appropriate web page.

To provide resilient data links, the situation in which there is no version of the destination available that is appropriate to the current context must be considered. In practice, this situation rarely arises and normally indicates a misplaced pointer. However, search algorithms should always have a fallback position. For example, if the above search is performed in a context of 1994, then the search algorithm may supply the earliest available version.

The pointer links are unbreakable, in the sense that the pointer links always match a suitable destination. However, the situation in which a returned page is out of context must be considered. This may occur when a specific link (which may be regarded as a degenerate pointer with a destination set of one) is followed, or when none of the potential destinations matches the current context.

In the Dog Act example above, consider an amending Act which changed s25A. Since the amendment in question gives rise to a specific version of s25A, any link to s25A must be implemented as a fixed link rather than a pointer. However, the current context date may be before the amendment was made, or after a subsequent amendment. In either case, the targeted s25A is not the ‘current’ version. An application in accordance with the principles of the present invention displays a message such as:

In order to view this version of s25A your current context date must be changed to Oct. 1, 1995,

Do you wish to proceed?

If the user answers “yes”, the pointer is followed and the context is adjusted accordingly. If “no”, the pointer is cancelled and the user returns to the page containing the pointer. The context date is not changed.

Utilising the above principles enables the markup and the Web application to freely employ pointers to implement intelligent, resilient links, and reduce the complexity of the required markup.

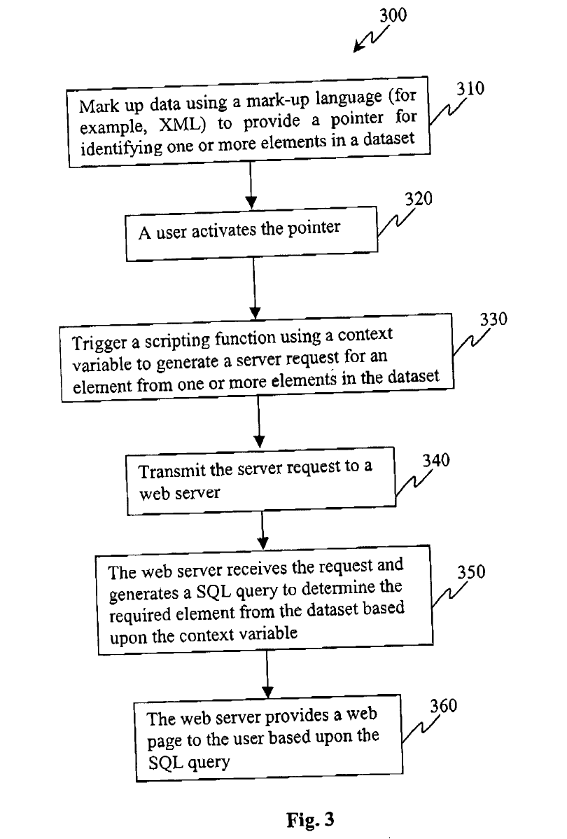

FIG. 3 shows a flow chart 300 for providing one or more resilient links in an electronic publication. In step 310, an electronic publication is marked-up using a markup language. XML is one such mark-up language that may be used. The step 310 provides a pointer in the electronic document that identifies one or More elements in a dataset.

In the example above of the Dog Act legislation, the pointer identified three versions of s25A of the Dog Act. In step 320, a user activates the pointer. Activation may take the form of clicking on the pointer or rolling the cursor over the pointer, depending on how the document has been marked up. Activating the pointer triggers a scripting function that utilises a context valuable to generate a server request, as shown in step 330. The context variable in the above example was the date. The server request seeks an element from the one or more elements of the dataset with which the pointer is associated.

In step 340, the scripting function transmits the server request to a web server. The web server receives the server request in step 350 and generates a SQL query to determine the appropriate element, based upon the context variable. The web server then provides, in step 360 an appropriate web page.

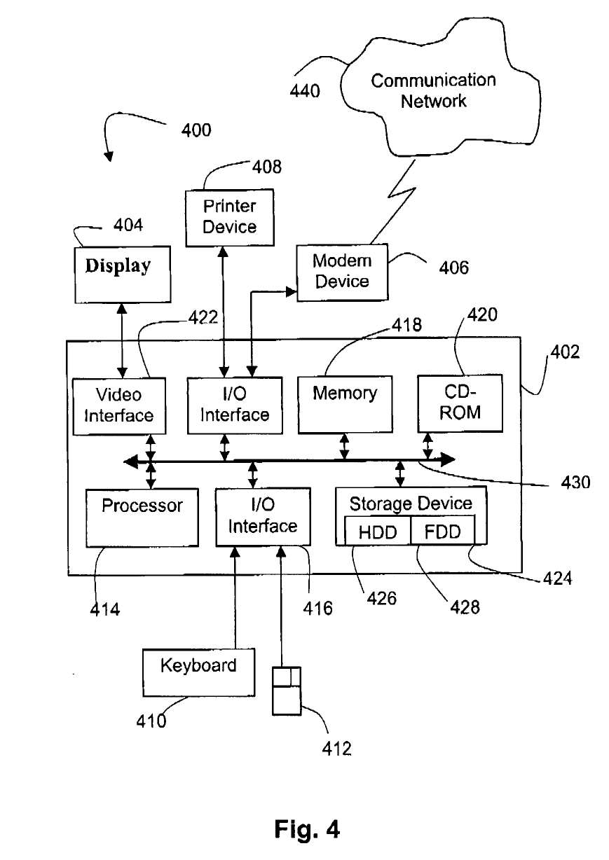

The method for providing one or more resilient links in an electronic publication is preferably practiced using a general-purpose computer system 400, such as that shown in FIG. 4, wherein the processes of FIGS. 1 to 3 may be implemented as software, such as an application program executing within the computer system 400. In particular, the steps of the method of FIG. 3 are effected by instructions in the software that are carried out by the computer. The instructions may be formed as one or more code modules, each for performing one or more particular tasks. The software may also be divided into two separate parts, in which a first part performs the FIG. 3 methods and a second part manages a user interface between the first part and the user. The software may be stored in a computer readable medium, including the storage devices described below, for example. The software is loaded into the computer from the computer readable medium, and then executed by the computer. A computer readable medium having such software or computer program recorded on it is a computer program product. The use of the computer program product in the computer preferably effects an advantageous apparatus for FIG. 3.

The computer system 400 comprises a computer module 401, input devices such as a keyboard 402 and mouse 403, output devices including a printer 415 and a display device 414. A Modulator-Demodulator (Modem) transceiver device 416 is used by the computer module 401 for communicating to and from a communications network 420, for example connectable via a telephone line 421 or other functional medium. The modem 416 can be used to obtain access to the Internet, and other network systems, such as a Local Area Network (LAN) or a Wide Area Network (WAN).

The computer module 401 typically includes at least one processor unit 405, a memory unit 406, for example formed from semiconductor random access memory (RAM) and read only memory (ROM), input/output (I/O) interfaces including a video interface 407, and an I/O interface 413 for the keyboard 402 and mouse 403 and optionally a joystick (not illustrated), and an interface 408 for the modem 416. A storage device 409 is provided and typically includes a hard disk drive 410 and a floppy disk drive 411. A magnetic tape drive (not illustrated) may also be used. A CD-ROM drive 412 is typically provided as a non-volatile source of data. The components 405 to 413 of the computer module 401, typically communicate via an interconnected bus 404 and in a manner which results in a conventional mode of operation of the computer system 400 known to those in the relevant art. Examples of computers on which the described arrangements can be practised include IBM-PC's and compatibles, Sun Sparcstations or alike computer systems evolved therefrom.

Typically, the application program is resident on the hard disk drive 410 and read and controlled in its execution by the processor 405. Intermediate storage of the program and any data fetched from the network 420 may be accomplished using the semiconductor memory 406, possibly in concert with the hard disk drive 410. In some instances, the application program may be supplied to the user encoded on a CD-ROM or floppy disk and read via the corresponding drive 412 or 411, or alternatively may be read by the user from the network 420 via the modem device 416. Still further, the software can also be loaded into the computer system 400 from other computer readable media. The term “computer readable medium” as used herein refers to any storage or transmission medium that participates in providing instructions and/or data to the computer system 400 for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 401. Examples of transmission media include radio or infra-red transmission channels as well as a network connection to another computer or networked device, and the Internet or Intranets including email transmissions and information recorded on websites and the like.

The method for providing one or more resilient links in an electronic publication may alternatively be implemented in dedicated hardware such as one or more integrated circuits performing the functions or sub functions of FIG. 3. Such dedicated hardware may include graphic processors, digital signal processors, or one or more microprocessors and associated memories.

Where reference is made in any one or more of the accompanying drawings to steps and/or features, which have the same reference numerals, those steps and/or features have for the purposes of this description the same function(s) or operation(s), unless the contrary intention appears.

### Industrial Applicability

It is apparent from the above that the arrangements described are applicable to the electronic publishing industry, the document management industry, any industry using manuals, and any industry using text-based XML encoded data.

The foregoing describes only some embodiments of the present invention, and modifications and/or changes can be made thereto without departing fron the scope and spirit of the invention, the embodiments being illustrative and not restrictive.

We claim:

1. A method for providing one or more resilient links in an electronic document using text-based data, said method including the steps of:
providing an XML dataset including a plurality of predefined portions of text-based data, each predefined portion of said text-based data being encoded using XML, and a plurality of attributes for organising said predefined portions of said text-based data;
embedding an XML link in said electronic document for at least partially identifying one or more predefined portions in said XML dataset;
generating a request for at least one of said partially identified predefined portions based upon activation of said embedded XML link; and
resolving said request using at least one current context variable to determine a specific one of said partially identified predefined portions.

2. The method according to claim 1, including the further step of providing said specific predefined portion.

3. The method according to claim 1, wherein said predefined portions include at least one modified and stored predefined portion encoded using XML, said attributes for organising said predefined portions and said modified predefined portion of said text-based data.

4. The method according to claim 1, wherein said generating step includes the step of triggering software functionality for generating said request when said link is activated.

5. The method according to claim 4, wherein said software functionality is implemented using a scripting language.

6. The method according to claim 5, wherein said scripting language is JavaScript.

7. The method according to claim 1, wherein said request includes said at least one current context variable.

8. The method according to claim 1, including the further step of transmitting said request to a document management system.

9. The method according to claim 8, wherein said document management system is a web server and said request is a server request.

10. The method according to claim 8, including the further step of:
generating by said document management system, on receipt of said request, a database query to determine said specific predefined portion dependent upon said at least one current context variable.

11. The method according to claim 10, further including the step of transmitting by said document management system said specific predefined portion based on said database query.

12. The method according to claim 11, wherein said requested element is a web page.

13. An apparatus for providing one or more resilient links in an electronic document using text-based data, said apparatus including:
means for providing an XML dataset including a plurality of predefined portions of text-based data, each predefined portion of said text-based data being encoded using XML, and a plurality of attributes for organising said predefined portions of said text-based data;
means for embedding an XML link in said electronic document for at least partially identifying one or more predefined portions in said XML dataset;
means for generating a request for at least one of said partially identified predefined portions based upon activation of said embedded XML link; and
means for resolving said request using at least one current context variable to determine a specific one of said partially identified predefined portions.

14. The apparatus according to claim 13, further including:
means for providing said specific predefined portion.

15. The apparatus according to claim 13, wherein said predefined portions include at least one modified and stored predefined portion encoded using XML, said attributes for organising said predefined portions and said modified predefined portion of said text-based data.

16. The apparatus according to claim 13, wherein said means for generating includes:
means for triggering software functionality for generating said request when said link is activated.

17. The apparatus according to claim 16, wherein said software functionality is implemented using a scripting language.

18. The apparatus according to claim 17, wherein said scripting language is JavaScript.

19. The apparatus according to claim 13, wherein said request includes said at least one current context variable.

20. The apparatus according to claim 13, further including:
means for transmitting said request to a document management system.

21. The apparatus according to claim 20, wherein said document management system is a web server and said request is a server request.

22. The apparatus according to claim 20, wherein said document management system generates, on receipt of said request, a database query to determine said specific predefined portion dependent upon said at least one current context variable.

23. The apparatus according to claim 22, wherein said document management system generates said specific predefined portion based on said database query.

24. The apparatus according to claim 23, wherein said requested element is a web page.

25. A computer program product having a computer readable medium having a computer program recorded therein for providing one or more resilient links in an electronic document using text-based data, said computer program product including:
computer program code means for providing an XML dataset including a plurality of predefined portions of text-based data, each predefined portion of said text-based data being encoded using XML, and a plurality of attributes for organising said predefined portions of said text-based data;
computer program code means for embedding an XML link in said electronic document for at least partially identifying one or more predefined portions in said XML dataset;
computer program code means for generating a request for at least one of said partially identified predefined portions based upon activation of said embedded XML link; and
computer program code means for resolving said request using at least one current context variable to determine a specific one of said partially identified predefined portions.

26. The computer program product according to claim 25, further including:
computer program code means for providing said specific predefined portion.

27. The computer program product according to claim 25, wherein said predefined portions include at least one modified and stored predefined portion encoded using XML, said attributes for organising said predefined portions and said modified predefined portion of said text-based data.

28. The computer program product according to claim 25, wherein said computer program code means for generating includes:
computer program code means for triggering software functionality for generating said request when said link is activated.

29. The computer program product according to claim 28, wherein said software functionality is implemented using a scripting language.

30. The computer program product according to claim 29, wherein said scripting language is JavaScript.

31. The computer program product according to claim 25, wherein said request includes said at least one current context variable.

32. The computer program product according to claim 25, further including:
computer program code means for transmitting said request to a document management system.

33. The computer program product according to claim 32, wherein said document management system is a web server and said request is a server request.

34. The computer program product according to claim 32, wherein said document management system generates, on receipt of said request, a database query to determine said specific predefined portion dependent upon said at least one current context variable.

35. The computer program product according to claim 34, wherein said document management system generates said specific predefined portion based on said database query.

36. The computer program product according to claim 35, wherein said requested element is a web page.
